(19) United States
(12) Patent Application Publication
(10) Pub. No.: US 2026/0200459 A1
(43) Pub. Date: Jul. 16, 2026

(54) ENGINE STARTING SYSTEM FOR ELECTRIC VEHICLE

(71) Applicant: Mazda Motor Corporation, Aki-gun, Hiroshima (JP)

(72) Inventors: Tadashi Saito, Aki-gun (JP); Yuki Hikichi, Aki-gun (JP); Takayuki Mikami, Aki-gun (JP); Shinji Takayama, Aki-gun (JP); Taiga Kamiji, Aki-gun (JP); Tomokuni Kusunoki, Aki-gun (JP)

(21) Appl. No.: 19/416,207

(22) Filed: Dec. 11, 2025

(30) Foreign Application Priority Data
Jan. 14, 2025 (JP) 2025-004530

(51) Int. Cl. B60W 20/40; B60W 10/02; B60W 10/06; B60W 10/08; B60W 20/19

(52) U.S. Cl. CPC B60W 20/40; B60W 10/02; B60W 10/06; B60W 10/08; B60W 20/19; B60W 2510/0657; B60W 2510/1005; B60W 2540/10; B60W 2710/0605; B60W 2710/0616; B60W 2710/0666; B60W 2710/083; B60W 2720/30

(57) ABSTRACT

An engine starting system for an electric vehicle includes a controller that switches between a first travel mode, in which a vehicle travels by torque of a motor, and a second travel mode, in which the vehicle travels by torque of a multicylinder engine and the motor. In a case where a switching condition from the first travel mode to the second travel mode is satisfied, the controller reduces an air amount supplied to the engine to a predetermined amount by engaging a clutch and reducing an opening amount of a throttle valve, and then supplies fuel to some cylinders of the engine to start cylinder cut-off operation of the engine; and supplies fuel to all the cylinders to switch the engine from the cylinder cut-off operation to full-cylinder operation in a case where a predetermined condition is satisfied after a start of the cylinder cut-off operation.

### TECHNICAL FIELD

The technique disclosed herein relates to an engine starting system for an electric vehicle.

### BACKGROUND ART

A conventional hybrid vehicle is disclosed in JP2000-120455A. This conventional hybrid vehicle is a parallel-type hybrid vehicle that travels by using power of one or both of an engine and an electric motor according to a travel condition. In this conventional hybrid vehicle, a throttle opening amount is substantially fully-closed during cranking at an engine start, and is then gradually changed to a throttle opening amount with which target torque, which is determined according to an operation state at the time, is obtained after complete explosion at the engine start. In this way, smooth drivability without torque shock and vibration is ensured for the conventional hybrid vehicle.

### SUMMARY

### TECHNICAL PROBLEM

There is a demand for suppression of noise that is produced at an engine start of an electric vehicle having the engine that is started during travel of the vehicle.

In the conventional hybrid vehicle, since the throttle opening amount is substantially fully-closed at the engine start, intake noise at the engine start can be reduced. However, since a measure against engine combustion noise is not taken for the conventional hybrid vehicle, there is room for improvement in suppression of the noise at the engine start.

The technique disclosed herein suppresses noise at an engine start.

### SOLUTION TO PROBLEM

The technique disclosed herein relates to an engine starting system for an electric vehicle. The engine starting system includes:

a multicylinder engine that is mounted on a vehicle and generates torque for travel of the vehicle;

a throttle valve that is located in an intake passage connected to the multicylinder engine and adjusts an air amount supplied to the multicylinder engine;

a fuel injection valve that is attached to the multicylinder engine and injects fuel supplied to cylinders of the multicylinder engine;

a motor that is mounted on the vehicle and generates torque for the travel of the vehicle together with or independently of the multicylinder engine;

a clutch that is located between the multicylinder engine and the motor, connects the multicylinder engine and the motor during engagement, and disconnects the multicylinder engine and the motor during disengagement; and

a controller that outputs a control signal of the throttle valve, the fuel injection valve, the motor, or the clutch, in which

the controller switches between a first travel mode, in which the vehicle travels by torque of the motor when the clutch disconnects the multicylinder engine and the motor, and a second travel mode, in which the vehicle travels by torque of the multicylinder engine and the motor when the clutch connects the multicylinder engine and the motor, and

in a case where a switching condition from the first travel mode to the second travel mode is satisfied, the controller is configured to:

reduce the air amount supplied to the multicylinder engine to a predetermined amount by engaging the clutch and reducing an opening amount of the throttle valve, and then supply fuel to some of the cylinders of the multicylinder engine to start a cylinder cut-off operation of the multicylinder engine; and

supply fuel to all the cylinders of the multicylinder engine to switch the multicylinder engine from the cylinder cut-off operation to full-cylinder operation in a case where a predetermined condition is satisfied after a start of the cylinder cut-off operation.

The multicylinder engine and the motor are mounted on the vehicle. The vehicle is a so-called hybrid vehicle. The multicylinder engine and the motor are mechanically connected via the clutch.

The controller switches between the first travel mode and the second travel mode. In the first travel mode, the clutch disconnects the multicylinder engine and the motor. The vehicle travels only by the torque of the motor. In the second travel mode, the clutch connects the multicylinder engine and the motor. The vehicle travels by the torque of both the multicylinder engine and the motor.

When the switching condition from the first travel mode to the second travel mode is satisfied, the multicylinder engine is started. The controller engages the clutch. The motor supplies starting torque to the multicylinder engine (that is, motoring).

At the start of the multicylinder engine, the controller reduces the opening amount of the throttle valve. Before the start of the multicylinder engine, the opening amount of the throttle valve may be set to an opening amount during idling operation of the multicylinder engine, for example. In this case, at the start of the multicylinder engine, the opening amount of the throttle valve can be reduced. When the opening amount of the throttle valve is reduced, the air amount supplied to the multicylinder engine is reduced, and intake noise at the start of the multicylinder engine is reduced.

After reducing the air amount supplied to the multicylinder engine to the predetermined amount, the controller supplies fuel to some of the cylinders of the multicylinder engine through the fuel injection valves, and thereby starts the cylinder cut-off operation of the multicylinder engine. Since combustion is performed only in some of the cylinders, combustion noise at the start of the multicylinder engine is reduced.

Since a reduction in the intake noise and a reduction in the combustion noise are combined, the engine starting system can suppress the noise at the start of the multicylinder engine.

In the case where the predetermined condition is satisfied after the start of the cylinder cut-off operation, the controller switches the multicylinder engine from the cylinder cut-off operation to the full-cylinder operation. Switching from the first travel mode to the second travel mode is completed.

Instead of switching the multicylinder engine in a stopped state to the full-cylinder operation, the multicylinder engine in the stopped state performs the cylinder cut-off operation once, and is then switched from the cylinder cut-off operation to the full-cylinder operation. As a result, a change in sound pressure at the start of the multicylinder engine is suppressed. The suppression of the change in the sound pressure suppresses an occupant of the vehicle from feeling discomfort.

The controller may divide a target torque in the second travel mode into the torque of the multicylinder engine and the torque of the motor, and

the controller may compensate for a reduction in the torque of the multicylinder engine during the cylinder cut-off operation by increasing the torque of the motor.

During the cylinder cut-off operation of the multicylinder engine, the torque generated by the multicylinder engine is relatively reduced. The motor increases the torque on the basis of the control by the controller. The increase in the torque of the motor compensates for the reduction in the torque of the multicylinder engine. It is possible to suppress the reduction in the torque or loss of the torque of the vehicle during switching from the first travel mode to the second travel mode.

In a case where a magnitude of an acceleration request by a driver is lower than a predetermined value when the switching condition is satisfied, the controller may reduce the amount of air supplied to the multicylinder engine to start the cylinder cut-off operation of the multicylinder engine, and then switches the multicylinder engine from the cylinder cut-off operation to the full-cylinder operation, and

in a case where the magnitude of the acceleration request is equal to or higher than the predetermined value, the controller may engage the clutch and start the full-cylinder operation without reducing the amount of air supplied to the multicylinder engine and performing the cylinder cut-off operation.

In the case where the magnitude of the acceleration request by the driver is relatively low, it is desirable to suppress the noise generated at the start of the multicylinder engine as much as possible. This is to suppress the driver from feeling discomfort. After reducing the air supply amount to the multicylinder engine and starting the cylinder cut-off operation of the multicylinder engine, the controller switches the multicylinder engine from the cylinder cut-off operation to the full-cylinder operation. Together with the suppression of the intake noise and the combustion noise, the change in the sound pressure at the start of the multicylinder engine is suppressed.

In the case where the magnitude of the acceleration request by the driver is relatively high, certain magnitudes are allowed even when the noise generated is loud and the change in the sound pressure is intense at the start of the multicylinder engine. The controller starts the full-cylinder operation of the multicylinder engine without reducing the air supply amount to the multicylinder engine and performing the cylinder cut-off operation. While the intake noise and the combustion noise are increased, and/or the change in the sound pressure is increased, the vehicle can be accelerated quickly. The vehicle can satisfy the acceleration request by the driver. Elimination of the reduction in the air supply amount to the multicylinder engine and the cylinder cut-off operation improves drivability of the vehicle.

In a case where a predetermined time has elapsed since the start of the cylinder cut-off operation, the controller may switch the multicylinder engine from the cylinder cut-off operation to the full-cylinder operation.

In the case where the multicylinder engine is switched from the cylinder cut-off operation to the full-cylinder operation after a lapse of the predetermined time since the start of the cylinder cut-off operation, the intense change in the sound pressure is suppressed.

The controller may reduce the predetermined time when the magnitude of the acceleration request by the driver is high compared to when the magnitude is low.

The loud noise or the intense change in the sound pressure is more likely to be allowed when the magnitude of the acceleration request by the driver is high. In the case where the predetermined time for switching from the cylinder cut-off operation to the full-cylinder operation is reduced when the magnitude of the acceleration request by the driver is high, it is possible to satisfy the relatively high acceleration request by the driver while suppressing the driver from feeling discomfort.

The controller may increase the predetermined time at a low gear stage of a transmission compared to at a high gear stage thereof.

In the case where the gear stage is the low gear stage during switching from the first travel mode to the second travel mode, the vehicle speed is relatively low. When the multicylinder engine is started at the low gear, the loud noise or the intense change in the sound pressure tends to make the occupant feel discomfort. Since the change in the sound pressure is suppressed by extending the predetermined time for switching from the cylinder cut-off operation to the full-cylinder operation, it is possible to suppress the occupant from feeling discomfort.

The controller may increase the opening amount of the throttle valve after the start of the cylinder cut-off operation.

The opening amount of the throttle valve, which has been reduced for a purpose of reducing the intake noise, is increased after the start of the cylinder cut-off operation. Since the air amount supplied to the multicylinder engine is increased, the multicylinder engine can be switched from the cylinder cut-off operation to the full-cylinder operation.

### ADVANTAGEOUS EFFECTS

The engine starting system for the electric vehicle can suppress the noise at the engine start.

### BRIEF DESCRIPTION OF DRAWINGS

FIG. 1 illustrates an electric vehicle on which an engine starting system is mounted.

FIG. 2 is a block diagram of the engine starting system.

FIG. 3 is a flowchart related to control of the engine starting system according to a control method.

FIG. 4 is a time chart of various parameters by control of the engine starting system.

### DESCRIPTION OF EMBODIMENTS

A description will hereinafter be made on an embodiment of an engine starting system for an electric vehicle with reference to the drawings. The engine starting system for the electric vehicle described herein is illustrative.

### Electric Vehicle

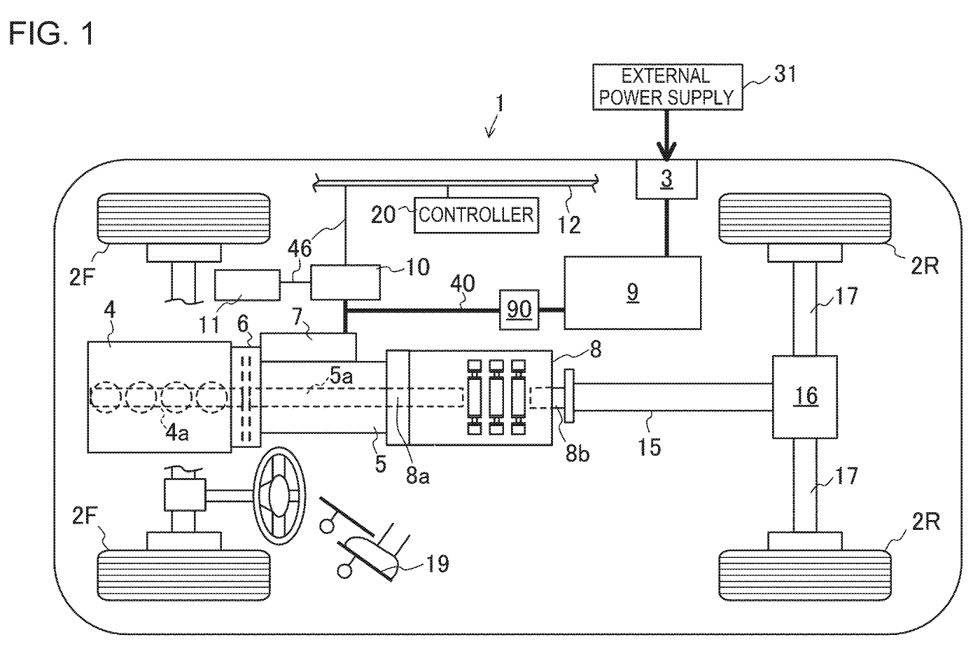

FIG. 1 illustrates an automobile 1 (that is, an example of the vehicle) to which the disclosed technique is applied. This automobile 1 is a hybrid vehicle capable of traveling by using electric power. The automobile 1 has four wheels in total that are front wheels 2F and rear wheels 2R.

An engine 4 and a motor 5 are mounted as drive sources on the automobile 1. These cooperate to drive the rear wheels 2R. When the rear wheels 2R are driven, the automobile 1 travels. The automobile 1 is a rear-wheel drive vehicle. The motor 5 is used not only as the drive source but also as a generator during regeneration.

A high-voltage battery 9 is mounted on this automobile 1. With supply of the electric power from the high-voltage battery 9, the motor 5 generates torque for travel of the automobile 1. An external power supply 31 is connected to the high-voltage battery 9 via a power supply port 3. The external power supply 31 charges the high-voltage battery 9. The automobile 1 is a so-called plug-in hybrid vehicle. However, the automobile 1 may be a hybrid vehicle that is not provided with the power supply port 3.

As devices of a drive system, the automobile 1 includes a clutch 6, an inverter 7, and an automatic transmission 8 as devices of a drive system in addition to the engine 4, the motor 5, and the like. The automobile 1 also includes a controller 20 as a device of a control system.

### Devices of Drive System

The engine 4 is an internal combustion engine that burns fossil fuel, for example. The engine 4 is a so-called four-stroke reciprocating engine that generates rotational power by repeating strokes of intake, compression, power, and exhaust.

The engine 4 is a spark ignition engine. However, the engine 4 may be a compression ignition engine. The engine 4 is a multicylinder engine having a plurality of cylinders. The engine 4 may be a four-cylinder engine. The number of the cylinders in the engine 4 is not limited to a specific number.

Various devices and mechanisms that are associated with the engine 4, such as an intake system, an exhaust system, a fuel supply system, and an ignition system, are installed in the automobile 1. The engine 4 will be described below.

The motor 5 is a permanent magnet type synchronous motor that is driven by three-phase alternating current (AC). The motor 5 is arranged in series behind the engine 4 via the clutch 6. The motor 5 is also arranged in series in front of the automatic transmission 8.

The clutch 6 is interposed between a front end portion of a shaft 5a of the motor 5 and a crankshaft 4a of the engine 4. The clutch 6 is switched between a state where the crankshaft 4a and the shaft 5a are coupled (that is, an engaged state) and a state where the crankshaft 4a and the shaft 5a are separated from each other (that is, a disengaged state).

A rear end portion of the shaft 5a of the motor 5 is coupled to an input shaft 8a of the automatic transmission 8. Accordingly, the engine 4 is coupled to the automatic transmission 8 via the clutch 6 and the shaft 5a. When the clutch 6 is in the disengaged state, the engine 4 is disconnected from the automatic transmission 8.

During travel of the automobile 1, the clutch 6 is switched between the engaged state and the disengaged state. For example, in the case where only the motor 5 generates the torque for the travel of the automobile 1, that is, when in a first travel mode, the clutch 6 is in the disengaged state. In the case where both the engine 4 and the motor 5 generate the torque for the travel of the automobile 1, that is, when in a second travel mode, the clutch 6 is in the engaged state.

The motor 5 is connected to the high-voltage battery 9 via the inverter 7 and a high-voltage cable 40. The high-voltage battery 9 is a battery that is mounted as a driving power supply on the vehicle. A contactor 90 is interposed in the high-voltage cable 40.

The high-voltage battery 9 supplies high-voltage direct current (DC) power to the inverter 7. The inverter 7 converts the DC power into three-phase AC and energizes the motor 5. The motor 5 is rotationally driven by energization of the motor 5. The motor 5 also supplies regenerative energy to the high-voltage battery 9.

The high-voltage battery 9 is also connected to a DC/DC converter 10 via the high-voltage cable 40. The DC/DC converter 10 converts the high-voltage DC power into 12 V low-voltage DC power for output. The DC/DC converter 10 is connected to a low-voltage battery 11 (a so-called lead acid battery) via a low-voltage cable 46.

The low-voltage battery 11 is connected to various electrical components via the low-voltage cable 46. The DC/DC converter 10 is also connected to a Controller Area Network (CAN) 12 via the low-voltage cable 46. The DC/DC converter 10 supplies low-voltage DC power to the CAN 12.

The automatic transmission 8 is a multistage automatic transmission (a so-called AT). The automatic transmission 8 has the input shaft 8a. The input shaft 8a is coupled to the shaft 5a of the motor 5. The automatic transmission 8 has an output shaft 8b. The output shaft 8b rotates independently of the input shaft 8a.

A gearshift mechanism that includes a plurality of planetary gear mechanisms, a plurality of friction fastening elements, and the like is incorporated between the input shaft 8a and the output shaft 8b. Each of the friction fastening elements is switched between a fastened state and an unfastened state by hydraulic pressure. The automatic transmission 8 selectively fastens the plurality of friction fastening elements by hydraulic control. A gear stage of the automatic transmission 8 is switched to one of a plurality of gear stages for forward travel from a first gear to an eighth gear and a gear stage for reverse travel.

As illustrated in FIG. 1, the output shaft 8b of the automatic transmission 8 is coupled to a differential gear 16 via a propeller shaft 15 that extends in a front-rear direction of a vehicle body. A pair of driveshafts 17, 17 that extend in a vehicle width direction and respectively coupled to the left and right rear wheels 2R, 2R are coupled to the differential gear 16. The rotational power that is output through the propeller shaft 15 is divided by the differential gear 16 and then transmitted to the rear wheels 2R through the paired driveshafts 17, 17.

### Engine

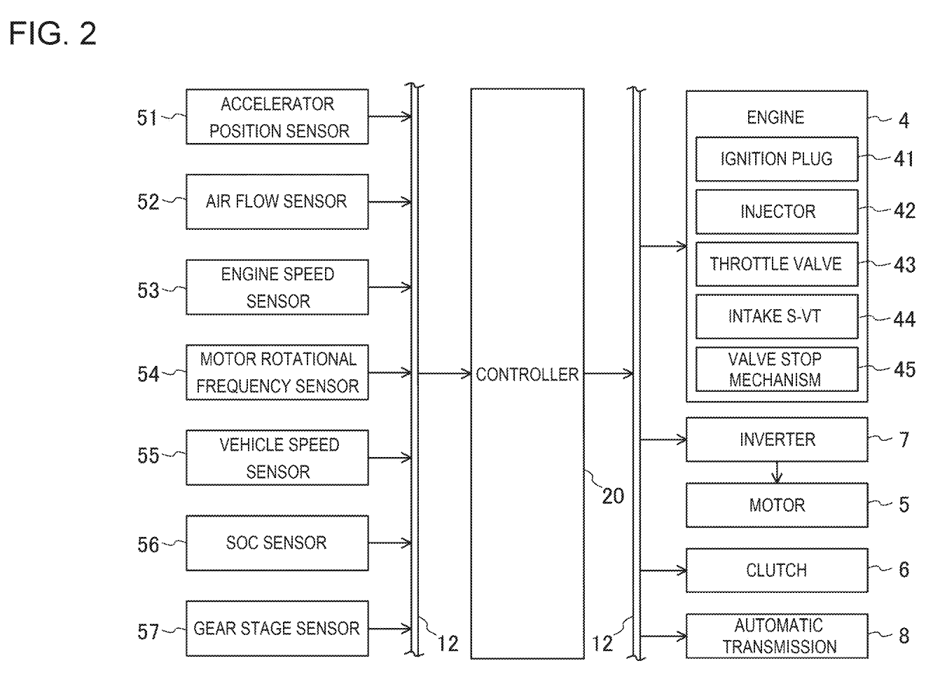

As illustrated in FIG. 2, the engine 4 includes an ignition plug 41, an injector 42, a throttle valve 43, an intake Sequential-Valve Timing (S-VT) 44, and a valve stop mechanism 45.

The ignition plug 41 is attached to the engine 4. The ignition plug 41 receives a control signal from the controller 20 and forcibly ignites an air-fuel mixture in the respective cylinder.

The injector 42 is attached to the engine 4. The injector 42 receives a control signal from the controller 20 and directly injects fuel into the respective cylinder, for example. Fuel and air suctioned into the respective cylinder form the air-fuel mixture. The injector 42 is an example of a fuel injection valve.

The throttle valve 43 is a butterfly valve that is located in an intake passage. The intake passage is connected to the engine 4. The throttle valve 43 receives a control signal from the controller 20 and changes an opening amount. When the opening amount of the throttle valve 43 is changed, an air amount to be supplied to the engine 4 is changed. As the opening amount of the throttle valve 43 is increased, the air amount is increased. When the opening amount of the throttle valve 43 is reduced, the air amount is reduced.

The intake S-VT 44 continuously changes opening/closing timing of an intake valve that is opened/closed in association with rotation of a camshaft, for example. The intake S-VT 44 is of a hydraulically driven type or an electrically driven type. In response to a control signal from the controller 20, the intake S-VT 44 changes the opening/closing timing of the intake valve in an advance direction or a retard direction. When the intake S-VT 44 changes the opening/closing timing of the intake valve, filling efficiency is changed. The change in the opening amount of the throttle valve 43 and the change in the opening/closing timing of the intake valve in combination change an intake air amount into the respective cylinder.

The valve stop mechanism 45 can stop opening/closing of the intake valve that is forcibly opened/closed in association with the rotation of the camshaft. A known hydraulic or electric mechanism can be adopted for the valve stop mechanism. The valve stop mechanism may be incorporated into a rocker arm that is interposed between the camshaft and the intake valve, for example. Alternatively, the valve stop mechanism may be incorporated into a lash adjuster that supports the rocker arm.

### Engine Starting System

FIG. 2 is a block diagram of a starting system for the engine 4. The above-described controller 20 is mounted on the automobile 1. The controller 20 controls the engine 4, the motor 5 (via the inverter 7), the clutch 6, the automatic transmission 8, and the like in response to an operation by the driver, and controls the travel of the automobile 1. The controller 20 includes hardware, such as a processor, memory, and an interface, and software, such as a database and a control program. Although the single controller 20 is illustrated in the starting system for the engine 4 in FIG. 2, the controller may be divided into a power-train control module (PCM) that mainly controls the actuation of the drive sources (the engine 4 and the motor 5) and a transmission control module (TCM) that mainly controls actuation of the clutch 6 and the automatic transmission 8. The PCM and the TCM are connected by the CAN 12 and are configured to be electrically communicable with each other.

The starting system for the engine 4 includes sensors that measure various parameters related to the travel of the vehicle. More specifically, the starting system for the engine 4 includes, for example, an accelerator position sensor 51, an air flow sensor 52, an engine speed sensor 53, a motor rotational frequency sensor 54, a vehicle speed sensor 55, a state of charge (SOC) sensor 56, and a gear stage sensor 57.

The accelerator position sensor 51 is attached to an accelerator pedal 19 (see FIG. 1) that is operated by the driver, and outputs a signal corresponding to the operation of the accelerator pedal 19. The air flow sensor 52 is located in the intake passage of the engine 4 and outputs a signal corresponding to a flow rate of the air that flows through the intake passage.

The engine speed sensor 53 is attached to the engine 4 and outputs a signal corresponding to a speed of the engine 4. The motor rotational frequency sensor 54 is attached to the motor 5 and outputs a signal corresponding to a rotational frequency of the motor 5. In the automobile 1, when the clutch 6 is in the engaged state and the engine 4 and the motor 5 each output the torque, the speed of the engine 4 matches the rotational frequency of the motor 5.

The vehicle speed sensor 55 is mounted on the automobile 1 and outputs a signal corresponding to a vehicle speed of the vehicle 1. The SOC sensor 56 outputs a signal corresponding to SOC of the high-voltage battery 9. The gear stage sensor 57 outputs a signal corresponding to the gear stage of the automatic transmission 8.

The controller 20 receives the signals output from these sensors via the CAN 12. The controller 20 outputs the control signal to each of the engine 4, the inverter 7, the clutch 6, and the automatic transmission 8 through the CAN 12. The controller 20 controls the engine 4, the motor 5, the clutch 6, and the automatic transmission 8.

### Control by Engine Starting System

In the automobile 1, when a predetermined start condition is satisfied during travel only by the motor 5, the engine 4 may be started. That is the start of the engine 4 that is associated with switching from the first travel mode to a second travel mode. The start condition can be exemplified by a fact that an acceleration request by the driver is increased by the depression of the accelerator pedal 19 by the driver. The start condition is not limited to this condition.

When noise at the start of the engine 4 is loud, an occupant feels uncomfortable. The starting system for the engine 4 disclosed herein can suppress noise at the start of the engine 4.

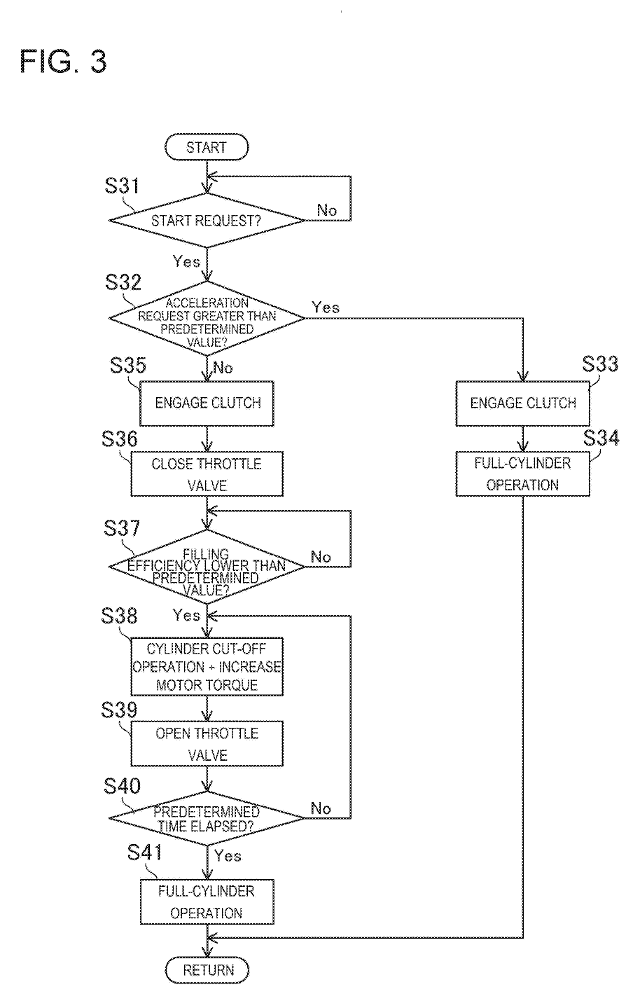

FIG. 3 is a flowchart illustrating a control procedure (method) at the start of the engine 4 by the starting system for the engine 4. In the flowchart of FIG. 3, it is possible to replace an order of steps, omit some of the steps, and add steps.

In step S31 after the start, the controller 20 determines whether there is a start request for the engine 4. The start request is a start request of the engine 4 related to switching from the first travel mode to the second travel mode described above. In the processing in FIG. 3, the processing in step S31 is repeated until there is the start request.

When there is the start request for the engine 4, in step S32, the controller 20 determines whether a magnitude of the acceleration request by the driver is equal to or greater than a predetermined value. The controller 20 acquires the magnitude of the acceleration request by the driver from the signal from the accelerator position sensor 51. More specifically, the controller 20 determines a magnitude of requested torque by the driver on the basis of the signal from the accelerator position sensor 51. In the case where a change in the requested torque is greater than a predetermined value, the controller 20 may determine that the magnitude of the acceleration request by the driver is equal to or greater than the predetermined value. Alternatively, in the case where a depression amount of the accelerator pedal 19 is larger than a predetermined value, the controller 20 may determine that the magnitude of the acceleration request by the driver is equal to or greater than the predetermined value. Further alternatively, in the case where a depression speed of the accelerator pedal 19 is faster than a predetermined value, the controller 20 may determine that the magnitude of the acceleration request is equal to or greater than the predetermined value.

If it is determined YES in step S32, the controller 20 engages the clutch 6 in step S33 to start the engine 4 by the motor 5. In the following step S34, the controller 20 supplies fuel to all the cylinders of the engine 4 through the injectors 42, and starts full-cylinder operation of the engine 4. The controller 20 does not suppress sound at the start of the engine 4 as described below. Accordingly, the noise generated at the start of the engine 4 is relatively loud, and a change in a sound pressure at the start of the engine 4 is relatively intense. Meanwhile, the automobile 1 can be accelerated quickly. The automobile 1 can satisfy the acceleration request by the driver. Drivability of the automobile 1 is improved.

If it is determined NO in step S32, the controller 20 engages the clutch 6 in step S35. Due to the engagement of the clutch 6, the motor 5 starts motoring of the engine 4.

In the following step S36, the controller 20 reduces the opening amount of the throttle valve 43. An intake air amount of the engine 4 is reduced. Due to the reduction in the intake air amount of the engine 4, intake noise is suppressed.

In step S37, the controller 20 determines whether the filling efficiency of the engine 4 has been reduced to a predetermined value or lower. In the processing in FIG. 3, the processing in step S37 is repeated until the filling efficiency is reduced to the predetermined value or lower.

If the filling efficiency has been reduced to the predetermined value or lower, in step S38, the controller 20 starts cylinder cut-off operation of the engine 4. More specifically, the controller 20 supplies fuel to only some of the cylinders of the engine 4 through the injectors 42. As a result, combustion is performed only in some of the cylinders. For example, in the four-cylinder engine 4, the combustion may be performed in the two cylinders. Here, the controller 20 stops opening/closing of the intake valves of the cylinders, in each of which the combustion is not performed, through the valve stop mechanism 45. The engine 4 during the cylinder cut-off operation can suppress combustion noise in comparison with that during the full-cylinder operation.

In addition, in step S38, the controller 20 increases the torque of the motor 5 to compensate for the torque that is reduced by the cylinder cut-off operation. The requested torque for the automobile 1 is satisfied by the torque of the engine 4 during the cylinder cut-off operation and the increased torque of the motor 5.

After the start of the cylinder cut-off operation, in step S39, the controller 20 increases the opening amount of the throttle valve 43. As will be described below, a required air amount is secured after the engine 4 is switched from the cylinder cut-off operation to the full-cylinder operation.

In step S40, the controller 20 determines whether a predetermined time has elapsed after the start of the cylinder cut-off operation. The controller 20 may include a timer for measuring a lapse of time. The cylinder cut-off operation of the engine 4 continues until the predetermined time elapses.

If the predetermined time has elapsed, in step S41, the controller 20 switches the engine 4 from the cylinder cut-off operation to the full-cylinder operation. That is, the controller 20 supplies fuel to all the cylinders through the injectors 42. The valve stop mechanism 45 terminates the stop of opening/closing of the intake valves of some of the cylinders.

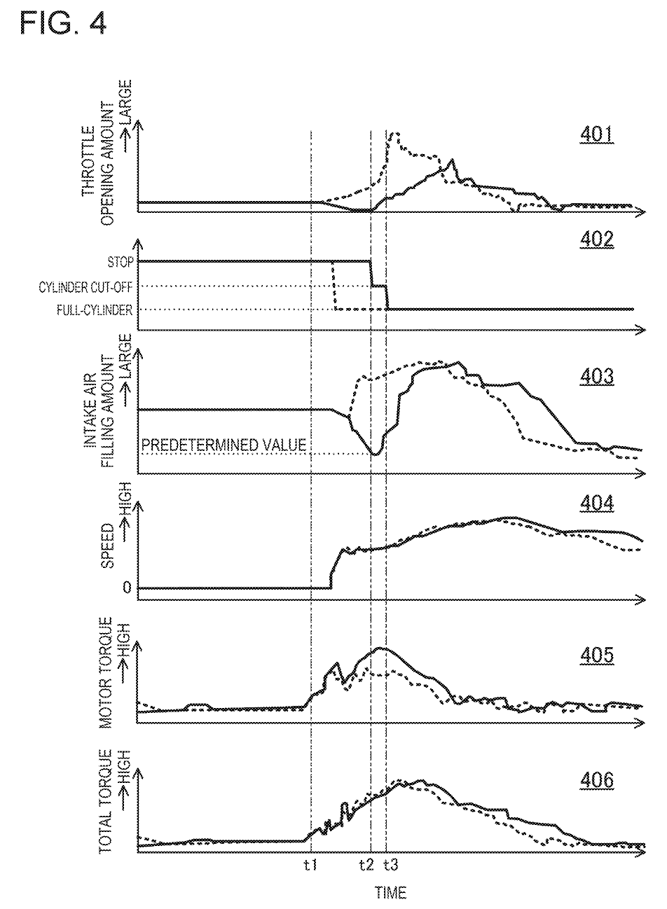

FIG. 4 is a time chart illustrating a change in each of the parameters through the control by the starting system of the engine 4. FIG. 4 includes (1) a change 401 in the opening amount of the throttle valve 43 of the engine 4, (2) an operation state of the engine 4, that is, a state change 402 of whether the engine 4 is stopped, is in the cylinder cut-off operation, or is in the full-cylinder operation, (3) a change 403 in an intake air filling amount, (4) a change 404 in the speed of the engine 4, (5) a change 405 in the torque of the motor 5, and (6) a change 406 in total torque of the torque of the engine 4 and the torque of the motor 5. In FIG. 4, a horizontal axis represents the lapse of time.

Solid lines in FIG. 4 indicate changes in the parameters in the case where, upon switching from the first travel mode to the second travel mode, an air supply amount to the engine 4 is reduced, and the cylinder cut-off operation thereof is performed by reducing the opening amount of the throttle valve 43 according to the flowchart in FIG. 3 (that is, as an example). Broken lines in FIG. 4 indicate a comparative example in which the air supply amount to the engine 4 is not reduced, and the cylinder cut-off operation is not performed upon switching from the first travel mode to the second travel mode. In each of the example and the comparative example, the magnitude of the acceleration request by the driver is equal.

Before time t1 in FIG. 4, the travel mode of the automobile 1 is the first travel mode. The speed of the engine 4 is zero, and the engine 4 is stopped. The automobile 1 travels only by the torque of the motor 5. While the engine 4 is stopped before the time t1, the opening amount of the throttle valve 43 is set to the opening amount during idling operation of the engine 4. The opening amount of the throttle valve 43 of the engine 4 is not fully closed.

At the time t1, a switching condition from the first travel mode to the second travel mode is satisfied. When the clutch 6 is engaged, the engine 4 is started. As illustrated in the chart 404, the speed of the engine 4 is increased.

The broken lines in FIG. 4 indicate the comparative example, and as described above, the controller 20 does not reduce the air supply amount to the engine 4 and does not perform the cylinder cut-off operation by reducing the opening amount of the throttle valve 43. In order to respond to the acceleration request by the driver, as indicated by the broken line in the chart 401, the controller 20 increases the opening amount of the throttle valve 43. In association with the increase of the opening amount of the throttle valve 43, the intake air filling amount is increased as indicated by the broken line in the chart 403. As indicated by the broken line in the chart 402, the operation state of the engine 4 is changed from the stopped state to the full-cylinder operation.

In contrast, the solid lines in FIG. 4 indicate the example according to the flowchart in FIG. 3. As indicated by the solid line in the chart 401, the controller 20 reduces the opening amount of the throttle valve 43.

As a result of the reduction of the opening amount of the throttle valve 43, as indicated by the solid line in the chart 403, the intake air filling amount of the engine 4 is gradually reduced. At time t2, when the intake air filling amount becomes equal to or less than the predetermined value, as indicated by the solid line in the chart 402, the operation state of the engine 4 is changed from the stopped state to the cylinder cut-off operation.

At the time t2 onward, as indicated by the solid line in the chart 401, the controller 20 increases the opening amount of the throttle valve 43. As indicated by the solid line in the chart 403, the intake air filling amount of the engine 4 is gradually increased.

Then, at time t3 at which a predetermined time elapses from the time t2, as indicated by the solid line in the chart 402, the operation state of the engine 4 is changed from the cylinder cut-off operation to the full-cylinder operation.

The torque of the engine 4 during the cylinder cut-off operation is relatively low. As indicated by the solid line in the chart 405, the motor 5 increases the torque to be greater than that in the comparative example indicated by the broken line. The torque of the motor 5 compensates for the reduction in the torque of the engine 4. Thus, as indicated by the solid line and the broken line in the chart 406, a sum of the torque of the engine 4 and the torque of the motor 5 is substantially the same even when the engine 4 performs the cylinder cut-off operation or when the engine 4 does not perform the cylinder cut-off operation.

As it has been described so far, the starting system for the engine 4 reduces the opening amount of the throttle valve 43 at the start of the engine 4 that is associated with switching from the first travel mode to the second travel mode (step S36 in FIG. 3). Since the supply air amount to the engine 4 is reduced, the intake noise at the start of the engine 4 can be reduced.

After reducing the supply air amount to the engine 4 to a predetermined amount, the starting system for the engine 4 supplies fuel to some of the cylinders of the engine 4, and starts the cylinder cut-off operation of the engine 4 (steps S37, S38). Since the combustion is performed only in some of the cylinders, it is possible to reduce the combustion noise at the start of the engine 4.

Since the reduction in the intake noise and the reduction in the combustion noise are combined, the starting system for the engine 4 can substantially reduce the noise at the start of the engine 4.

If the predetermined time has elapsed since the start of the cylinder cut-off operation, the starting system for the engine 4 switches the engine 4 from the cylinder cut-off operation to the full-cylinder operation (steps S40, S41).

Instead of switching the engine 4 in the stopped state to the full-cylinder operation, the engine 4 in the stopped state performs the cylinder cut-off operation once, and is then switched from the cylinder cut-off operation to the full-cylinder operation. Thus, the change in the sound pressure at the start of the engine 4 is suppressed. By suppressing the change in the sound pressure, it is possible to suppress the occupant of the automobile 1 from feeling discomfort.

In the case where the magnitude of the acceleration request by the driver is relatively low, that is, if it is determined NO in step S32, the starting system for the engine 4 reduces the air supply amount and performs the cylinder cut-off operation. Since the noise generated at the start of the engine can be suppressed as much as possible, it is possible to suppress the driver from feeling discomfort.

If the magnitude of the acceleration request by the driver is relatively high, the starting system for the engine 4 does not reduce the air supply amount to the engine 4 and does not perform the cylinder cut-off operation (steps S33, S34). This is because certain magnitudes are allowed even when the noise generated is large and the change in the sound pressure is intense at the start of the engine 4. In this case, the engine 4 in the stopped state starts the full-cylinder operation. The automobile 1 can be accelerated promptly to satisfy the high acceleration request by the driver.

In addition, after the start of the cylinder cut-off operation, the starting system for the engine 4 increases the opening amount of the throttle valve 43 (step S39). In this way, the engine 4, which has been started and switched to the full-cylinder operation, can generate the torque that satisfies the driver's request.

### Modified Examples

In step S40 of FIG. 3, the predetermined time for continuing the cylinder cut-off operation may be a fixed value that is set in advance. The predetermined time may be a variable value. For example, in the case where the magnitude of the acceleration request by the driver is high, the predetermined time may be set shorter than that when the magnitude is low.

The large noise or the intense change in the sound pressure is more likely to be allowed when the magnitude of the acceleration request by the driver is high at the start of the engine 4. In the case where the predetermined time for switching from the cylinder cut-off operation to the full-cylinder operation is reduced when the magnitude of the acceleration request by the driver is high, it is possible to satisfy the relatively high acceleration request by the driver while suppressing the driver from feeling discomfort.

In addition, the predetermined time may be longer when the automatic transmission 8 is at the low gear stage than that at the high gear stage.

In the case where the gear stage is the low gear stage when the engine 4 is started for switching from the first travel mode to the second travel mode, the vehicle speed is relatively low. When the engine 4 is started at the low gear, the loud noise tends to cause the occupant to feel discomfort. Since the change in the sound pressure is suppressed by extending the predetermined time for switching from the cylinder cut-off operation to the full-cylinder operation, it is possible to suppress the occupant from feeling discomfort.

In step S40 of FIG. 3, instead of waiting for the lapse of the predetermined time from the start of the cylinder cut-off operation, the controller 20 may switch the cylinder cut-off operation to the full-cylinder operation when the opening amount of the throttle valve 43 is increased and the filling efficiency exceeds a second predetermined value. The second predetermined value is higher than the predetermined value in step S37.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

1: automobile (vehicle)

20: controller

4: engine

42: injector (fuel injection valve)

43: throttle valve

5: motor

6: clutch

8: automatic transmission

What is claimed is:

1. An engine starting system for an electric vehicle, the engine starting system comprising:
a multicylinder engine that is mounted on a vehicle and generates torque for travel of the vehicle;
a throttle valve that is located in an intake passage connected to the multicylinder engine and adjusts an air amount supplied to the multicylinder engine;
a fuel injection valve that is attached to the multicylinder engine and injects fuel supplied to cylinders of the multicylinder engine;
a motor that is mounted on the vehicle and generates torque for the travel of the vehicle together with or independently of the multicylinder engine;
a clutch that is located between the multicylinder engine and the motor, connects the multicylinder engine and the motor during engagement, and disconnects the multicylinder engine and the motor during disengagement; and
a controller that outputs a control signal of the throttle valve, the fuel injection valve, the motor, or the clutch, wherein
the controller switches between a first travel mode, in which the vehicle travels by torque of the motor when the clutch disconnects the multicylinder engine and the motor, and a second travel mode, in which the vehicle travels by torque of the multicylinder engine and the motor when the clutch connects the multicylinder engine and the motor, and
in a case where a switching condition from the first travel mode to the second travel mode is satisfied, the controller is configured to:
reduce the air amount supplied to the multicylinder engine to a predetermined amount by engaging the clutch and reducing an opening amount of the throttle valve, and then supply fuel to some of the cylinders of the multicylinder engine to start a cylinder cut-off operation of the multicylinder engine; and
supply fuel to all the cylinders of the multicylinder engine to switch the multicylinder engine from the cylinder cut-off operation to a full-cylinder operation in a case where a predetermined condition is satisfied after a start of the cylinder cut-off operation.

2. The engine starting system according to claim 1, wherein
the controller divides a target torque in the second travel mode into the torque of the multicylinder engine and the torque of the motor, and
the controller compensates for a reduction in the torque of the multicylinder engine during the cylinder cut-off operation by increasing the torque of the motor.

3. The engine starting system according to claim 1, wherein
in a case where a magnitude of an acceleration request by a driver is lower than a predetermined value when the switching condition is satisfied, the controller reduces the amount of air supplied to the multicylinder engine to start the cylinder cut-off operation, and then switches the multicylinder engine from the cylinder cut-off operation to the full-cylinder operation, and
in a case where the magnitude of the acceleration request is equal to or higher than the predetermined value, the controller engages the clutch and starts the full-cylinder operation without reducing the amount of air supplied to the multicylinder engine and performing the cylinder cut-off operation.

4. The engine starting system according to claim 1, wherein in a case where a predetermined time has elapsed since the start of the cylinder cut-off operation, the controller switches the multicylinder engine from the cylinder cut-off operation to the full-cylinder operation.

5. The engine starting system according to claim 4, wherein the controller reduces the predetermined time when the magnitude of the acceleration request by the driver is high compared to when the magnitude is low.

6. The engine starting system according to claim 4, wherein the controller increases the predetermined time at a low gear stage of a transmission compared to at a high gear stage thereof.

7. The engine starting system according to claim 1, wherein the controller increases the opening amount of the throttle valve after the start of the cylinder cut-off operation.

8. An engine starting method for an electric vehicle including a multicylinder engine that is mounted on a vehicle and generates torque for travel of the vehicle, a throttle valve that is located in an intake passage connected to the multicylinder engine and adjusts an air amount supplied to the multicylinder engine, a fuel injection valve that is attached to the multicylinder engine and injects fuel supplied to cylinders of the multicylinder engine, a motor that is mounted on the vehicle and generates torque for the travel of the vehicle together with or independently of the multicylinder engine, a clutch that is located between the multicylinder engine and the motor, connects the multicylinder engine and the motor during engagement and disconnects the multicylinder engine and the motor during disengagement, and a controller that outputs a control signal of the throttle valve, the fuel injection valve, the motor, or the clutch, the engine starting method comprising:
switching the controller between a first travel mode, in which the vehicle travels by torque of the motor when the clutch disconnects the multicylinder engine and the motor, and a second travel mode, in which the vehicle travels by torque of the multicylinder engine and the motor when the clutch connects the multicylinder engine and the motor, and
in a case where a switching condition from the first travel mode to the second travel mode is satisfied, via the controller:
reducing the air amount supplied to the multicylinder engine to a predetermined amount by engaging the clutch and reducing an opening amount of the throttle valve, and then supplying fuel to some of the cylinders of the multicylinder engine to start a cylinder cut-off operation of the multicylinder engine; and
supplying fuel to all the cylinders of the multicylinder engine to switch the multicylinder engine from the cylinder cut-off operation to a full-cylinder operation in a case where a predetermined condition is satisfied after a start of the cylinder cut-off operation.

9. The engine starting method according to claim 8, further comprising, at the controller:
dividing a target torque in the second travel mode into the torque of the multicylinder engine and the torque of the motor, and
compensating for a reduction in the torque of the multicylinder engine during the cylinder cut-off operation by increasing the torque of the motor.

10. The engine starting method according to claim 8, further comprising, at the controller:
in a case where a magnitude of an acceleration request by a driver is lower than a predetermined value when the switching condition is satisfied, reducing the amount of air supplied to the multicylinder engine to start the cylinder cut-off operation, and then switching the multicylinder engine from the cylinder cut-off operation to the full-cylinder operation, and
in a case where the magnitude of the acceleration request is equal to or higher than the predetermined value, engaging the clutch and starting the full-cylinder operation without reducing the amount of air supplied to the multicylinder engine and performing the cylinder cut-off operation.

11. The engine starting method according to claim 8, further comprising, at the controller, in a case where a predetermined time has elapsed since the start of the cylinder cut-off operation, switching the multicylinder engine from the cylinder cut-off operation to the full-cylinder operation.

12. The engine starting method according to claim 11, further comprising, at the controller, reducing the predetermined time when the magnitude of the acceleration request by the driver is high compared to when the magnitude is low.

13. The engine starting method according to claim 11, further comprising, at the controller, increasing the predetermined time at a low gear stage of a transmission compared to at a high gear stage thereof.

14. The engine starting method according to claim 8, further comprising, at the controller, increasing the opening amount of the throttle valve after the start of the cylinder cut-off operation.
